(19) United States
(12) Patent Application Publication
(10) Pub. No.: US 2016/0278041 A1
(43) Pub. Date: Sep. 22, 2016

(54) PAGING IN COMMUNICATIONS

(71) Applicant: NOKIA SOLUTIONS AND NETWORKS OY, Espoo (FI)

(72) Inventors: Frank FREDERIKSEN, Klarup (DK); Mads LAURIDSEN, Aalborg Ost (DK)

(21) Appl. No.: 15/031,973

(22) PCT Filed: Nov. 6, 2013
(86) PCT No.: PCT/EP2013/073143

§ 371 Date: Apr. 25, 2016

(51) Int. Cl. H04W 68/00; H04W 68/02

(52) U.S. Cl. CPC H04W 68/005; H04W 68/02

(57) ABSTRACT

A method and an apparatus are disclosed for managing paging in a communications system. The method may include, based on a received set of physical resources, determining, in a terminal apparatus, an original paging pattern defining potential time instants for paging, wherein the potential time instants for paging include a subset of a total amount of resources available at a network node for paging.

### FIELD OF THE INVENTION

The exemplary and non-limiting embodiments of this invention relate generally to wireless communications networks, and more particularly to a paging procedure.

### BACKGROUND ART

The following description of background art may include insights, discoveries, understandings or disclosures, or associations together with disclosures not known to the relevant art prior to the present invention but provided by the invention. Some such contributions of the invention may be specifically pointed out below, whereas other such contributions of the invention will be apparent from their context.

Paging refers to a procedure by which a mobile network attempts to reach a user equipment (UE) within its location area. The user equipment is allocated a paging interval and a specific sub-frame within the paging interval where a paging message may be sent. A sufficient discontinuous reception (DRX) cycle is ensured for devices to save power and to ensure fast enough response time for an incoming call and/or connection request.

### SUMMARY

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

Various aspects of the invention comprise methods, apparatuses, and a computer program product as defined in the independent claims. Further embodiments of the invention are disclosed in the dependent claims.

An aspect of the invention relates to a method for managing paging in a communications system, the method comprising based on a received set of physical resources, determining, in a terminal apparatus, an original paging pattern defining potential time instants for paging, wherein the potential time instants for paging comprise a subset of a total amount of resources available at a network node for paging.

A further aspect of the invention relates to a first apparatus comprising at least one processor; and at least one memory including a computer program code, wherein the at least one memory and the computer program code are configured to, with the at least one processor, cause the first apparatus to perform any of the method steps.

A still further aspect of the invention relates to a second apparatus comprising at least one processor; and at least one memory including a computer program code, wherein the at least one memory and the computer program code are configured to, with the at least one processor, cause the second apparatus to transmit, to a user terminal, a set of physical resources to be used by the user terminal for reception of paging information, in order the user terminal to be able to determine, based on the set of physical resources, an original paging pattern defining potential time instants for paging, wherein the potential time instants for paging comprise a subset of a total amount of resources available at the second apparatus for paging.

A still further aspect of the invention relates to a computer program product comprising program instructions which, when run on a computing apparatus, causes the computing apparatus to perform the method steps

Although the various aspects, embodiments and features of the invention are recited independently, it should be appreciated that all combinations of the various aspects, embodiments and features of the invention are possible and within the scope of the present invention as claimed.

### BRIEF DESCRIPTION OF THE DRAWINGS

In the following the invention will be described in greater detail by means of exemplary embodiments with reference to the attached drawings, in which

FIG. 1 illustrates paging setup according to an exemplary embodiment;

FIG. 2 shows a simplified block diagram illustrating exemplary system architecture;

FIG. 3 shows a simplified block diagram illustrating exemplary apparatuses;

FIG. 4 shows a messaging diagram illustrating an exemplary messaging event according to an embodiment of the invention;

FIG. 5 shows a schematic diagram of a flow chart according to an exemplary embodiment of the invention;

FIG. 6 shows a schematic diagram of a flow chart according to an exemplary embodiment of the invention.

### DETAILED DESCRIPTION OF SOME EMBODIMENTS

Future wireless communication systems may potentially be successors (either evolutionary or revolutionary) of the 3GPP LTE system, following an evolution path compared to the current LTE-A system with roughly the same numerology and baseline thinking. However, there is also a chance or risk that the system introduces disruptive thinking and changes the ways that different procedures are performed. In the current concept work, there are thoughts on either dropping the IDLE/RRC_IDLE mode state that is typically present in mobile and wireless communication systems, or introducing another similar state that allows for low UE power consumption. However, one of the benefits of the IDLE/RRC_IDLE mode operation is that it facilitates the possibility to have low power consumption at the UE side at the cost of increased latency in the sense that any “waking up” or paging operation from the network side to UE is delayed. This low level power consumption may also be achieved by using deep sleep in a connected mode.

Changing of state from active to idle and vice versa has also been shown to cause excessive UE power consumption and delays, and therefore it is of interest to avoid UE state changes.

A problem with the paging operation as it is defined currently is that UE has to listen for paging information at pre-determined paging occasions in LTE paging scheme, and there is no flexibility for UE to choose exactly when to listen for a paging message. The current paging procedure has been designed with reduction of network load in focus and hence UE may be forced to listen for the paging messages far more often compared to the quality of service (QoS) that UE is planning to deliver to its user.

In an exemplary embodiment, some considerations are presented on how to allow for more UE flexibility for choosing when to listen for paging information, such that UE may potentially optimize its power consumption at the cost of increased network load. The increased network load is not to be seen as a main showstopper for small cells with excessive capacity, and furthermore the signalling caused by idle/active state changes may be completely avoided. An increased latency is not an issue because UE updates its paging interval to match the requested QoS.

The paging procedure that is used in existing systems is based on fixed and static paging procedures. That is, a base station defines a certain set of resources that are used as paging resources (in the time and frequency domain). At these time instants, UE is listening to potential paging messages while being in IDLE mode (basically for situations where UE does not have an active connection).

An exemplary embodiment allows UE to have some flexibility of autonomously defining some listening time instants. An exemplary embodiment provides a paging procedure allowing UE freedom in choosing reception instants. An exemplary embodiment introduces a framework for providing some UE flexibility in choosing which paging instants are to be used for reception of the paging information based on some parameters or configurations. These may be, but not limited to one or more of current QoS requirements, UE capability, UE category, battery level and connectivity to a power supply etc. To ensure that UE reception of a paging message happens at some point in time, an exemplary embodiment also proposes to have a “guaranteed paging listen interval”, such that UE makes sure that within x seconds, it definitely listens for at least one of the paging instants.

In an exemplary embodiment, it is anticipated that the base station (or evolved node-B—eNB—in 3GPP terminology, or access point—AP—in IEEE terminology) defines a set of physical resources that are used for potential transmission of paging information. This pre-defined set of physical resources may be conveyed to UE as system broadcast information, wherein UE determines the possible time instants for paging. These time instants for potential paging may be a subset of the total amount of resources available at the base station for paging, such that it is possible to have automatic division of resources for paging. On top of this, UE may potentially select (or negotiate with BS) another pattern which is a subset of the original paging pattern as being available to UE for paging.

In an exemplary embodiment, the pattern that UE originally derives from the BS broadcast information is denoted, for example, as “BS may page pattern”, while the UE-selected/negotiated pattern has an exemplary naming of “UE may listen pattern”.

It should be noted that this approach is significantly different from the existing systems in terms of paging, as in existing systems UE is expected to listen at each and every paging possibility.

An exemplary embodiment allows UE some freedom to select at which specific time instants it wants to listen for the paging channel (for instance, UE may change its listening behaviour based on different parameters such as for instance power source availability, expected quality of service, battery charge level, etc).

In an exemplary embodiment, it is also suggested to introduce a “UE shall listen” window, which basically means that UE (when operating in this mode) guarantees to BS that UE performs at least one (or a predefined number of) paging message decoding attempt(s). This “UE shall listen” window is most likely to be a predefined parameter from specifications, which is allowed to change through negotiations between BS and UE.

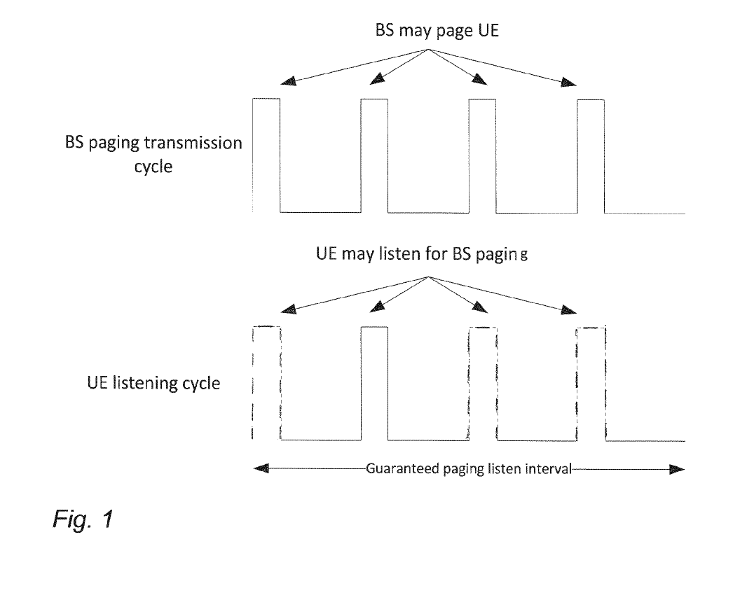

FIG. 1 illustrates paging setup according to an exemplary embodiment as seen from the base station and from UE perspective respectively.

An exemplary embodiment suggests avoiding the state change signalling, hence achieving a lower UE power consumption. For example, the state RRC_IDLE may be completely dropped, and UE may be kept in some kind of “global RRC connected mode” all the time. Alternatively, UE may be kept in a “light RRC connected mode” in which state UE may potentially maintain the RRC state and also be aware of a UE identification within a cell or tracking area of a set of cells.

Thus, an exemplary embodiment relates to LTE-A/LTE and situations where it is not easy to get a network connection, focusing on paging. In existing systems, UE does not have an option to select when to listen for the paging message; it has to listen for paging information at pre-defined times. Such a fixed mechanism may affect the energy/power efficiency of UE. An exemplary embodiment provides flexibility to UE so that UE is in a position to select when it listens for the paging message, by making UE to consider its current QoS requirements, battery level and/or connectivity to a power supply etc. as a factor for when to decide to enter into a paging listening mode. Thus UE is able to optimise its own power consumption according to its need of service.

Exemplary embodiments will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments. Like reference numerals refer to like elements throughout.

The present invention is applicable to any user terminal, network node, server, corresponding component, and/or to any communication system or any combination of different communication systems that support a paging procedure. The communication system may be a fixed communication system or a wireless communication system or a communication system utilizing both fixed networks and wireless networks. The protocols used, the specifications of communication systems, servers and user terminals, especially in wireless communication, develop rapidly. Such development may require extra changes to an embodiment. Therefore, all words and expressions should be interpreted broadly and they are intended to illustrate, not to restrict, the embodiment.

In the following, different embodiments will be described using, as an example of a system architecture whereto the embodiments may be applied, an architecture based on LTE (or LTE-A) (long term evolution (advanced long term evolution)) network elements, without restricting the embodiment to such an architecture, however. The embodiments described in these examples are not limited to the LTE radio systems but can also be implemented in other radio systems, such as 3G, 4G, 5G, B4G, UMTS (universal mobile telecommunications system), GSM, EDGE, WCDMA, bluetooth network, WLAN, WiMAX or other fixed, mobile or wireless network. In an embodiment, the presented solution may be applied between elements belonging to different but compatible systems such as LTE and UMTS.

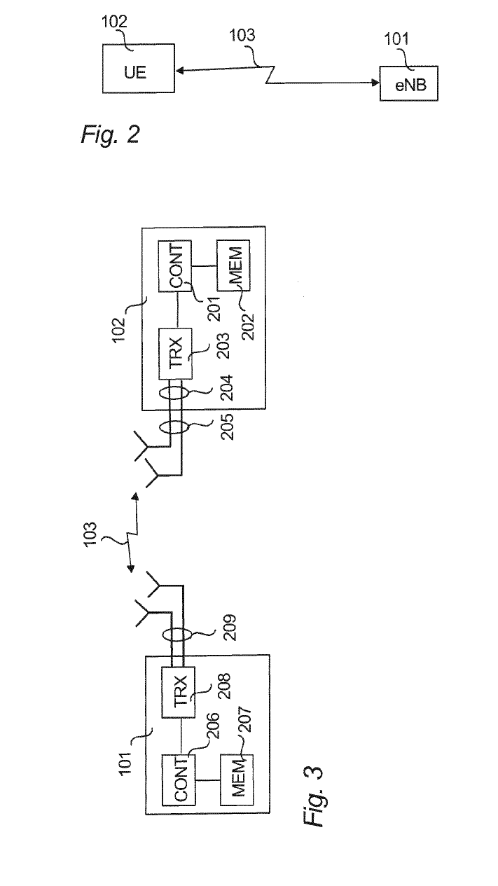

A general architecture of a communication system is illustrated in FIG. 2. FIG. 2 is a simplified system architecture only showing some elements and functional entities, all being logical units whose implementation may differ from what is shown. The connections shown in FIG. 2 are logical connections; the actual physical connections may be different. It is apparent to a person skilled in the art that the systems also comprise other functions and structures. It should be appreciated that the functions, structures, elements and the protocols used in or for a paging procedure, are irrelevant to the actual invention. Therefore, they need not to be discussed in more detail here.

The exemplary radio system of FIG. 2 comprises a network node 101 of a network operator. The network node 101 may include e.g. an LTE/LTE-A base station (eNB), radio network controller (RNC), or any other network element, or a combination of network elements. The network node 101 may be connected to one or more core network (CN) elements (not shown in FIG. 2) such as a mobile switching centre (MSC), MSC server (MSS), mobility management entity (MME), gateway GPRS support node (GGSN), serving GPRS support node (SGSN), home location register (HLR), home subscriber server (HSS), visitor location register (VLR). In FIG. 2, the radio network node 101 that may also be called eNB (enhanced node-B, evolved node-B) or network apparatus of the radio system, hosts the functions for radio resource management in a public land mobile network. FIG. 2 shows one or more user equipment 102 located in the service area of the radio network node 101. The user equipment refers to a portable computing device, and it may also be referred to as a user terminal. Such computing devices include wireless mobile communication devices operating with or without a subscriber identification module (SIM) in hardware or in software, including, but not limited to, the following types of devices: mobile phone, smart-phone, personal digital assistant (PDA), handset, laptop computer. In the example situation of FIG. 2, the user equipment 102 is capable of connecting to the radio network node 101 via a connection 103.

FIG. 3 is a block diagram of an apparatus according to an embodiment of the invention. FIG. 3 shows a user equipment 102 located in the area of a radio network node 101. The user equipment 102 is configured to be in connection with the radio network node 101. The user equipment or UE 102 comprises a controller 201 operationally connected to a memory 202 and a transceiver 203. The controller 201 controls the operation of the user equipment 102. The memory 202 is configured to store software and data. The transceiver 203 is configured to set up and maintain a wireless connection 103 to the radio network node 101. The transceiver 203 is operationally connected to a set of antenna ports 204 connected to an antenna arrangement 205. The antenna arrangement 205 may comprise a set of antennas. The number of antennas may be one to four, for example. The number of antennas is not limited to any particular number. The user equipment 102 may also comprise various other components, such as a user interface, camera, and media player. They are not displayed in the figure due to simplicity. The radio network node 101, such as an LTE/LTE-A base station (eNode-B, eNB) comprises a controller 206 operationally connected to a memory 207, and a transceiver 208. The controller 206 controls the operation of the radio network node 101. The memory 207 is configured to store software and data. The transceiver 208 is configured to set up and maintain a wireless connection to the user equipment 102 within the service area of the radio network node 101. The transceiver 208 is operationally connected to an antenna arrangement 209. The antenna arrangement 209 may comprise a set of antennas. The number of antennas may be two to four, for example. The number of antennas is not limited to any particular number. The radio network node 101 may be operationally connected (directly or indirectly) to another network element (not shown in FIG. 2) of the communication system, such as a radio network controller (RNC), a mobility management entity (MME), an MSC server (MSS), a mobile switching centre (MSC), a radio resource management (RRM) node, a gateway GPRS support node, an operations, administrations and maintenance (OAM) node, a home location register (HLR), a visitor location register (VLR), a serving GPRS support node, a gateway, and/or a server, via an interface. The embodiments are not, however, restricted to the network given above as an example, but a person skilled in the art may apply the solution to other communication networks provided with the necessary properties. For example, the connections between different network elements may be realized with internet protocol (IP) connections.

Although the apparatus 101, 102 has been depicted as one entity, different modules and memory may be implemented in one or more physical or logical entities. The apparatus may also be a user terminal which is a piece of equipment or a device that associates, or is arranged to associate, the user terminal and its user with a subscription and allows a user to interact with a communications system. The user terminal presents information to the user and allows the user to input information. In other words, the user terminal may be any terminal capable of receiving information from and/or transmitting information to the network, connectable to the network wirelessly or via a fixed connection. Examples of the user terminals include a personal computer, a game console, a laptop (a notebook), a personal digital assistant, a mobile station (mobile phone), a smart phone, and a line telephone.

The apparatus 101, 102 may generally include a processor, controller, control unit or the like connected to a memory and to various interfaces of the apparatus. Generally the processor is a central processing unit, but the processor may be an additional operation processor. The processor may comprise a computer processor, application-specific integrated circuit (ASIC), field-programmable gate array (FPGA), and/or other hardware components that have been programmed in such a way to carry out one or more functions of an embodiment.

The memory 202, 207 may include volatile and/or non-volatile memory and typically stores content, data, or the like. For example, the memory 202, 207 may store computer program code such as software applications (for example for the detector unit and/or for the adjuster unit) or operating systems, information, data, content, or the like for a processor to perform steps associated with operation of the apparatus in accordance with embodiments. The memory may be, for example, random access memory (RAM), a hard drive, or other fixed data memory or storage device. Further, the memory, or part of it, may be removable memory detachably connected to the apparatus.

The techniques described herein may be implemented by various means so that an apparatus implementing one or more functions of a corresponding mobile entity described with an embodiment comprises not only prior art means, but also means for implementing the one or more functions of a corresponding apparatus described with an embodiment and it may comprise separate means for each separate function, or means may be configured to perform two or more functions. For example, these techniques may be implemented in hardware (one or more apparatuses), firmware (one or more apparatuses), software (one or more modules), or combinations thereof. For a firmware or software, implementation can be through modules (e.g. procedures, functions, and so on) that perform the functions described herein. The software codes may be stored in any suitable, processor/computer-readable data storage medium(s) or memory unit(s) or article(s) of manufacture and executed by one or more processors/computers. The data storage medium or the memory unit may be implemented within the processor/computer or external to the processor/computer, in which case it can be communicatively coupled to the processor/computer via various means as is known in the art.

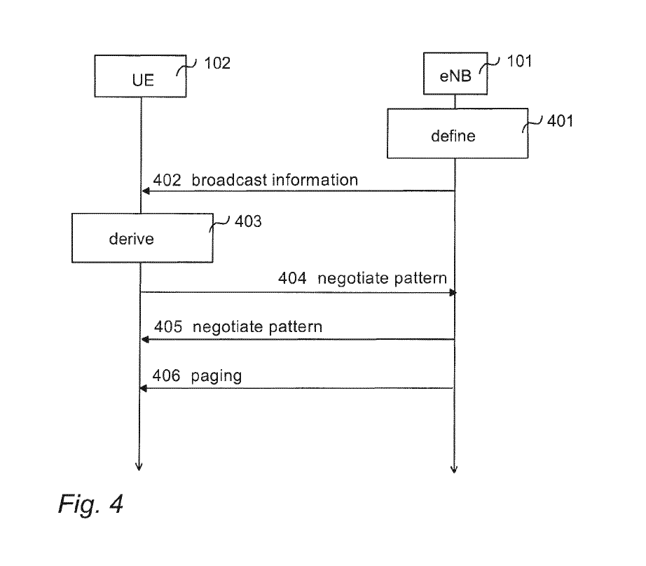

The signalling chart of FIG. 4 illustrates the required signalling. In the example of FIG. 4, a network node 101 (which may comprise e.g. a LTE/LTE-A-capable base station (eNode-B, eNB)) may define, in item 401, a set of physical resources to be used for potential reception of paging information. In item 402, eNB 101 may transmit this predefined set of physical resources to another network element (network node 102, e.g. a user terminal, UE) as system broadcast information (or through higher layer signalling, such as RRC signalling). In item 403, UE 102 may determine possible time instants for paging (i.e. an original paging pattern). These time instants for potential paging may be a subset of the total amount of resources available at eNB 101 for paging, such that it is possible to have automatic division of resources for paging. Further, in item 403, UE 102 may potentially determine another paging pattern which is a subset of the original paging pattern as being available to UE 102 for paging. Alternatively UE 102 may negotiate said another paging pattern (which is a subset of the original paging pattern as being available to UE 102 for paging) with eNB 101 e.g. by transmitting/receiving corresponding negotiate pattern messages 404, 405 to/from eNB 101. The paging pattern that UE 102 originally derives 403 from the BS broadcast information 402 may be denoted, for example, as “BS may page pattern”, and the paging pattern determined 403/negotiated by UE 102 may be denoted, for example, as “UE may listen pattern”. In order to ensure that eNB 101 does not have to waste too much resources to page UE 102, a “UE shall listen” window may be introduced which means that UE 102 (when operating in this mode) is able to guarantee to eNB 101 that UE 102 performs at least one (or a predefined number of) paging message decoding attempt(s). This “UE shall listen” window may be a predefined parameter which may be allowed to change through negotiations between eNB 101 and UE 102 (not shown in FIG. 4). In item 406, eNB 101 may transmit a paging message to UE 102.

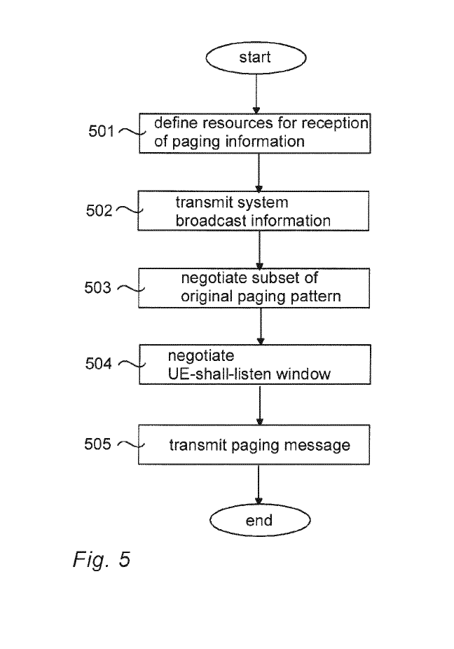

FIG. 5 is a flow chart illustrating an exemplary embodiment. The apparatus 101, which may comprise e.g. a network element (network node 101, e.g. a LTE/LTE-A base station, eNB) may define, in item 501, a set of physical resources to be used for potential reception of paging information. In item 502, eNB 101 may transmit this predefined set of physical resources to another network element (network node 102, e.g. a user terminal, UE) as system broadcast information. In item 503, eNB 101 may negotiate with UE 102 a paging pattern (which is a subset of an original paging pattern being available to UE 102 for paging) e.g. by receiving/transmitting corresponding negotiate pattern messages 404, 405 from/to UE 102. The negotiated paging pattern may be denoted, for example, as a “UE may listen pattern”. In order to ensure that eNB 101 does not have to waste too much resources to page UE 102, a “UE shall listen” window may be introduced which means that UE 102 (when operating in this mode) is able to guarantee to eNB 101 that UE 102 performs at least one (or a predefined number of) paging message decoding attempt(s). This “UE shall listen” window may be a predefined parameter which may be allowed to change, in item 504, through negotiations with UE 102. In item 505, a paging message may be transmitted from eNB 101 to UE 102. This means that multiple transmissions of paging messages are transmitted 505 from eNB 101, since the “UE shall listen” window only provides a guarantee that UE listens for a subset of opportunities.

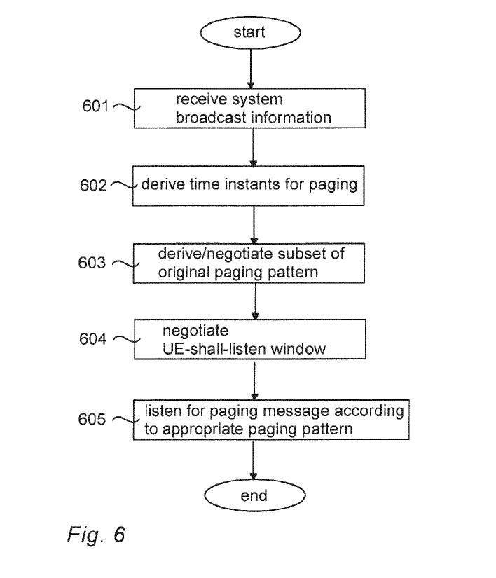

FIG. 6 is a flow chart illustrating an exemplary embodiment. The apparatus 102, which may comprise e.g. a network element (network node, e.g. a user terminal, UE) receives, in item 601, from a network apparatus 101 (which may comprise e.g. a LTE base station eNB 101), as system broadcast information, a set of physical resources to be used for potential reception of paging information. In item 602, UE 102 may determine possible time instants for paging (i.e. an original paging pattern). These time instants for potential paging may be a subset of the total amount of resources available at eNB 101 for paging, such that it is possible to have automatic division of resources for paging. In item 603, UE 102 may potentially determine another paging pattern which is a subset of the original paging pattern as being available to UE 102 for paging. Alternatively UE 102 may negotiate 603 said another paging pattern (which is a subset of the original paging pattern as being available to UE 102 for paging) with eNB 101 e.g. by transmitting/receiving corresponding negotiate pattern messages to/from eNB 101. The paging pattern that UE 102 originally derives 602 from the BS broadcast information may be denoted herein, for example, as “BS may page pattern”, and the paging pattern determined/negotiated 603 by UE 102 may be denoted, for example, as “UE may listen pattern”. In order to ensure that eNB 101 does not have to waste too much resources to page UE 102, a “UE shall listen” window may be introduced which means that UE 102 (when operating in this mode) is able to guarantee to eNB 101 that UE 102 performs at least one (or a predefined number of) paging message decoding attempt(s). This “UE shall listen” window may be a predefined parameter which may be allowed to change through negotiations 604 between eNB 101 and UE 102. In item 605, UE 102 may receive a paging message from eNB 101. It should be noted that the above notations for the patterns are only exemplary and they are pointing at the functionality of the patterns; the actual naming of the patterns may differ from the given one.

The steps/points, signalling messages and related functions described above in FIGS. 1 to 6 are in no absolute chronological order, and some of the steps/points may be performed simultaneously or in an order differing from the given one. Other functions can also be executed between the steps/points or within the steps/points and other signalling messages sent between the illustrated messages. Some of the steps/points or part of the steps/points can also be left out or replaced by a corresponding step/point or part of the step/point. The apparatus operations illustrate a procedure that may be implemented in one or more physical or logical entities. The signalling messages are only exemplary and may even comprise several separate messages for transmitting the same information. In addition, the messages may also contain other information.

Thus, according to an exemplary embodiment, there is provided a method for managing paging in a communications system, the method comprising based on a received set of physical resources, determining, in a terminal apparatus, an original paging pattern defining potential time instants for paging, wherein the potential time instants for paging comprise a subset of a total amount of resources available at a network node for paging.

According to another exemplary embodiment, the method comprises receiving, in the terminal apparatus from the network node, a set of physical resources to be used by the terminal apparatus for reception of paging information, the set of physical resources being defined by the network node.

According to yet another exemplary embodiment, the method comprises receiving, in the terminal apparatus from the network node, the set of physical resources as system broadcast information.

According to yet another exemplary embodiment, the method comprises receiving, in the terminal apparatus from the network node, the set of physical resources through radio resource control RRC signalling or other higher layer signalling.

According to yet another exemplary embodiment, the method comprises determining, in the terminal apparatus, a further paging pattern which is a subset of the original paging pattern.

According to yet another exemplary embodiment, the method comprises negotiating, in the terminal apparatus with the network node, a further paging pattern which is a subset of the original paging pattern.

According to yet another exemplary embodiment, the original paging pattern comprises a BS-may-page pattern, and the further paging pattern comprises a UE-may-listen pattern.

According to yet another exemplary embodiment, the method comprises introducing a UE-shall-listen time window order to reduce the amount of resources to be used by the network node to page the terminal apparatus, wherein the terminal apparatus, when operating in a UE-shall-listen mode, is able to guarantee to the network node that the terminal apparatus performs at least one or a predefined number of paging message decoding attempts.

According to yet another exemplary embodiment, the UE-shall-listen window comprises a predefined parameter, the value of which is redefinable in the terminal apparatus through negotiations with the network node.

According to yet another exemplary embodiment, the method comprises providing the terminal apparatus with flexibility to choose which time instants are to be used for reception of the paging information based on one or more of QoS requirements, terminal apparatus capability, terminal apparatus category, battery level and connectivity to a power supply.

According to yet another exemplary embodiment, the method comprises avoiding state change signalling to achieve a lower power consumption of the terminal apparatus.

According to yet another exemplary embodiment, there is provided a first apparatus comprising at least one processor; and at least one memory including a computer program code, wherein the at least one memory and the computer program code are configured to, with the at least one processor, cause the first apparatus to perform any of the method steps.

According to yet another exemplary embodiment, there is provided a second apparatus comprising at least one processor; and at least one memory including a computer program code, wherein the at least one memory and the computer program code are configured to, with the at least one processor, cause the second apparatus to transmit, to a user terminal, a set of physical resources to be used by the user terminal for reception of paging information, in order the user terminal to be able to determine, based on the set of physical resources, an original paging pattern defining potential time instants for paging, wherein the potential time instants for paging comprise a subset of a total amount of resources available at the second apparatus for paging.

According to yet another exemplary embodiment, the at least one memory and the computer program code are configured to, with the at least one processor, cause the second apparatus to transmit, to the user terminal, the set of physical resources as system broadcast information.

According to yet another exemplary embodiment, the at least one memory and the computer program code are configured to, with the at least one processor, cause the second apparatus to define the set of physical resources.

According to yet another exemplary embodiment, the at least one memory and the computer program code are configured to, with the at least one processor, cause the second apparatus to negotiate, with the user terminal, a further paging pattern which is a subset of the original paging pattern.

According to yet another exemplary embodiment, there is provided a computer program product comprising program instructions which, when run on a computing apparatus, causes the computing apparatus to perform the method steps.

It will be obvious to a person skilled in the art that, as the technology advances, the inventive concept can be implemented in various ways. The invention and its embodiments are not limited to the examples described above but may vary within the scope of the claims.

### LIST OF ABBREVIATIONS

QoS quality of service

UE user equipment

BS base station

eNB evolved node-B

3GPP 3^{rd} generation partnership project

B4G beyond-4G

4G 4^{th} generation

5G 5^{th} generation

LTE-A advanced long term evolution

LTE long term evolution

RRC radio resource control

1. A method for managing paging in a communications system, the method comprising:
determining, in a terminal apparatus based on a received set of physical resources, an original paging pattern defining potential time instants for paging, wherein the potential time instants for paging comprise a subset of a total amount of resources available at a network node for paging.

2. A method according to claim 1, comprising:
receiving, in the terminal apparatus from the network node, a set of physical resources to be used by the terminal apparatus for reception of paging information, the set of physical resources being defined by the network node.

3. A method according to claim 1, comprising:
receiving, in the terminal apparatus from the network node, the set of physical resources as system broadcast information.

4. A method according to claim 1, comprising:
receiving, in the terminal apparatus from the network node, the set of physical resources through radio resource control RRC signalling or other higher layer signalling.

5. A method as claimed in claim 1, comprising:
determining, in the terminal apparatus, a further paging pattern which is a subset of the original paging pattern.

6. A method as claimed in claim 1, comprising:
negotiating, in the terminal apparatus with the network node, a further paging pattern which is a subset of the original paging pattern.

7. A method as claimed in claim 5 wherein the original paging pattern comprises a BS-may-page pattern, and the further paging pattern comprises a UE-may-listen pattern.

8. A method as claimed in claim 1, comprising:
introducing a UE-shall-listen time window order to reduce the amount of resources to be used by the network node to page the terminal apparatus, wherein the terminal apparatus when operating in a UE-shall-listen mode, is able to guarantee to the network node that the terminal apparatus performs at least one or a predefined number of paging message decoding attempts.

9. A method according to claim 8, wherein the UE-shall-listen window comprises a predefined parameter, the value of which is redefinable in the terminal apparatus through negotiations with the network node.

10. A method as claimed in claim 1, comprising:
providing the terminal apparatus with flexibility to choose which time instants are to be used for reception of the paging information based on one or more of: QoS requirements, terminal apparatus capability, terminal apparatus category, battery level and connectivity to a power supply.

11. A method as claimed in claim 1, comprising:
avoiding state change signalling to achieve a lower power consumption of the terminal apparatus.

12. An apparatus comprising at least one processor; and at least one memory including a computer program code, wherein the at least one memory and the computer program code are configured to, with the at least one processor, cause the apparatus to perform the method of claim 1.

13. An apparatus comprising at least one processor; and at least one memory including a computer program code, wherein the at least one memory and the computer program code are configured to, with the at least one processor, cause the apparatus to:
transmit, to a user terminal, a set of physical resources to be used by the user terminal for reception of paging information, in order the user terminal to be able to determine, based on the set of physical resources, an original paging pattern defining potential time instants for paging, wherein the potential time instants for paging comprise a subset of a total amount of resources available at the second apparatus for paging.

14. An apparatus according to claim 13, wherein the at least one memory and the computer program code are configured to, with the at least one processor, cause the second apparatus to:
transmit, to the user terminal, the set of physical resources as system broadcast information.

15. An apparatus according to claim 13, wherein the at least one memory and the computer program code are configured to, with the at least one processor, cause the apparatus to define the set of physical resources.

16. An apparatus according to claim 13, wherein the at least one memory and the computer program code are configured to, with the at least one processor, cause the apparatus to negotiate, with the user terminal, a further paging pattern which is a subset of the original paging pattern.

17. A computer program product comprising program instructions which, when run on a computing apparatus, causes the computing apparatus to perform a method according to claim 1.
